(19) United States
(12) Patent Application Publication
(10) Pub. No.: US 2019/0207448 A1
(43) Pub. Date: Jul. 4, 2019

(54) MOTOR ROTOR, TURBOCHARGER, AND METHOD OF MANUFACTURING MOTOR ROTOR

(71) Applicant: IHI Corporation, Koto-ku (JP)

(72) Inventor: Takuya OZASA, Koto-ku (JP)

(73) Assignee: IHI Corporation, Koto-ku (JP)

(21) Appl. No.: 16/314,246

(22) PCT Filed: Jun. 7, 2017
(86) PCT No.: PCT/JP2017/021174

§ 371 Date: Dec. 28, 2018

(30) Foreign Application Priority Data
Jul. 13, 2016 (JP) 2016-138586

(51) Int. Cl. H02K 1/30; H02K 1/27; H02K 15/03; F02B 37/10; F02B 39/10

(52) U.S. Cl. CPC H02K 1/30; H02K 1/2753; F02B 39/10; F02B 37/10; H02K 15/03

(57) ABSTRACT

A motor rotor of the present disclosure includes an annular magnet, a tubular outer cover member that covers an outer circumferential surface of the magnet, and a different member that is located at a position outside the magnet in an axial direction of the magnet. The magnet includes one or a plurality of first recesses indicating an intermediate position between magnetic poles adjacent to each other in a circumferential direction of the magnet. The different member includes one or a plurality of second recesses provided in the circumferential direction of the magnet to correspond to positions of the first recesses. In a state in which the outer cover member covers the magnet, the second recesses are disposed at positions visually recognizable from outside.

### TECHNICAL FIELD

The present disclosure relates to a motor rotor, a turbocharger, and a method of manufacturing a motor rotor.

### BACKGROUND ART

In the related art, as a turbocharger, an electric turbocharger including an electric motor which applies a rotation driving force to a compressor impeller coupled to a rotary shaft is known (for example, refer to Patent Literature 1). The electric motor mounted in the turbocharger disclosed in Patent Literature 1 includes a motor rotor (rotor) fixed to the rotary shaft. This motor rotor includes an inner sleeve which is mounted in the rotary shaft, a permanent magnet which surrounds this inner sleeve around the shaft, and a cylindrical outer sleeve which surrounds this permanent magnet around the shaft.

### CITATION LIST

### Patent Literature

Patent Literature 1: Japanese Unexamined Patent Publication No. 2007-336737

### SUMMARY OF INVENTION

### Technical Problem

According to a technology in the related art, after components (an inner sleeve, a magnet, and an outer sleeve) constituting a motor rotor are assembled, a magnetic force of the magnet is increased by magnetizing the magnet. Although marks indicating polarities are provided in the magnet, after the motor rotor is assembled, the magnet is covered with other components such as the outer sleeve, so that the marks indicating the polarities cannot be visually recognized from the outside. Therefore, according to the technology in the related art, after the motor rotor is assembled, the magnetic force of the magnet is preliminarily increased a little by performing preliminary magnetization, and then the polarities are discriminated by measuring the magnetic force of the magnet. This magnetization is performed by disposing the motor rotor such that its polarities are aligned with those of a magnetization apparatus. In this manner, a magnetic force has been efficiently increased by performing this magnetization in consideration of positions of polarities of a magnet.

However, as described above, when a magnetic force is measured after preliminary magnetization is performed, and the polarities of a magnet are discriminated, it takes time and labor. Therefore, there has been room for improvement in a step of assembling a motor.

The present disclosure describes a motor rotor, a turbocharger, and a method of manufacturing a motor rotor, in which working steps can be simplified and efficiency of assembling work can be improved.

### Solution to Problem

According to the present disclosure, there is provided a motor rotor including an annular magnet, a tubular outer cover member that covers an outer circumferential surface of the magnet, and a different member that is located at a position outside the magnet in an axial direction of the magnet. The magnet includes one or a plurality of first recesses indicating an intermediate position between magnetic poles adjacent to each other in a circumferential direction of the magnet. The different member includes one or a plurality of second recesses provided in the circumferential direction of the magnet to correspond to positions of the first recesses. In a state in which the outer cover member covers the magnet, the second recesses are disposed at positions visually recognizable from outside.

### Effects of Invention

According to the present disclosure, working steps can be simplified and efficiency of assembling work can be improved when the magnet of the motor rotor is magnetized.

### BRIEF DESCRIPTION OF DRAWINGS

FIG. 1 is a cross-sectional view illustrating an electric turbocharger equipped with an electric motor including a motor rotor according to a first embodiment of the present disclosure.

FIG. 2 in an enlarged cross-sectional view illustrating the motor rotor in FIG. 1.

FIG. 3 is a front view illustrating the motor rotor in FIG. 2 in an axial direction.

FIGS. 4A to 4E are views illustrating an assembling procedure of the motor rotor.

FIGS. 5A and 5B are side views illustrating the motor rotor in a state in which a recess provided in a magnet and a recess provided in an inner sleeve are positionally aligned.

FIGS. 6A and 6B are views illustrating a magnetizing step of the motor rotor.

FIGS. 7A and 7B are views illustrating a magnetizing step of the motor rotor including a quadrupole magnet. FIGS. 7C and 7D are views illustrating a magnetizing step of the motor rotor including a hexapole magnet.

FIG. 8A is a side view illustrating a motor rotor according to a first modification example, FIG. 8B is a side view illustrating a motor rotor according to a second modification example, FIG. 8C is a side view illustrating a motor rotor according to a third modification example, and FIG. 8D is a side view illustrating a motor rotor according to a fourth modification example.

### DESCRIPTION OF EMBODIMENTS

According to the present disclosure, there is provided a motor rotor including an annular magnet, a tubular outer cover member that covers an outer circumferential surface of the magnet, and a different member that is located at a position outside the magnet in an axial direction of the magnet. The magnet includes one or a plurality of first recesses indicating an intermediate position between magnetic poles adjacent to each other in a circumferential direction of the magnet. The different member includes one or a plurality of second recesses provided in the circumferential direction of the magnet to correspond to positions of the first recesses. In a state in which the outer cover member covers the magnet, the second recesses are disposed at positions visually recognizable from outside.

In this motor rotor, the magnet is covered with the outer cover member, so that the first recesses cannot be seen from the outside. Even in a state in which the first recesses cannot be seen from the outside, the second recesses provided to correspond to the positions of the first recesses are disposed at the positions visually recognizable from the outside. Thus, the intermediate position between the magnetic poles adjacent to each other in the circumferential direction can be ascertained and a direction in which the magnetic poles face each other can be discriminated by checking the positions of the second recesses. Therefore, when the magnet is magnetized during assembling of the motor rotor, the magnet can be disposed at a correct position and can be magnetized while the positions of the second recesses are visually recognized. As a result, it is no longer necessary to perform preliminary magnetization and to ascertain the direction of the magnetic poles of the magnet, as in the related art. Accordingly, working steps can be simplified and work efficiency can be improved.

A pair of the second recesses symmetrically disposed with an axis of the magnet interposed therebetween may be configured to be formed in a radial direction of the magnet in the different member. In this configuration, since the pair of the second recesses are symmetrically disposed with the axis of the magnet interposed therebetween, misalignment of a rotation center of the magnet can be minimized. Time and labor for balance correction can be reduced when misalignment of the rotation center of the motor rotor is calibrated. If the pair of the second recesses are symmetrically formed with the axis of the magnet interposed therebetween, the positions of the second recesses can be easily ascertained, so that the motor rotor can be promptly disposed at a correct position when magnetization is performed.

The different member may be configured to include an inner sleeve inserted through the inside of an opening portion of the magnet. The inner sleeve may be configured to include a bulging portion which bulges to a position on an outer side of the magnet in the axial direction of the magnet. The second recesses may be configured to be provided in the bulging portion of the inner sleeve. Accordingly, the motor rotor can be disposed at a correct position and can be magnetized while the second recesses formed in the inner sleeve are visually recognized.

The second recesses may be configured to be formed in a part of the different member on the magnet side in the axial direction of the magnet. Accordingly, the second recesses can be disposed close to the first recesses formed in the magnet. Therefore, positions of the second recesses can be aligned with the first recesses in an accurate manner.

The second recesses may be configured to be formed at positions on an outer side of the outer cover member in the axial direction of the magnet. Accordingly, the second recesses can be disposed at positions not covered with the outer cover member, and the second recesses can be disposed at positions easily and visually recognized.

The different member may be configured to include a flange portion which bulges to an outer side beyond an inner circumferential surface of the magnet in the radial direction of the magnet. The second recesses may be configured to be formed in an outer circumferential edge portion of the flange portion. Accordingly, the second recesses can be provided in the outer circumferential edge portion of the flange portion disposed at a position on the outer side beyond the inner circumferential surface of the magnet in the radial direction of the magnet, and the second recesses can be disposed at positions more easily and visually recognized. In addition, the second recesses can be disposed at positions where working is easily performed.

According to the present disclosure, there is provided a turbocharger equipped with an electric motor including the motor rotor described above. The turbocharger includes a rotary shaft, a turbine impeller that is coupled to one end side of the rotary shaft, a compressor impeller that is coupled to the other end side of the rotary shaft, and the electric motor that includes the motor rotor mounted in the rotary shaft.

This turbocharger includes the motor rotor described above. Therefore, when the magnet of the motor rotor is magnetized, the intermediate position between the magnetic poles of the magnet can be ascertained and the direction in which the magnetic poles face each other can be discriminated by checking the positions of the second recesses. Therefore, the position of the magnet can be disposed at a correct position and can be magnetized, so that it is no longer necessary to perform preliminary magnetization and to ascertain the direction of the magnetic poles of the magnet, as in the related art. As a result, working steps can be simplified and work efficiency can be improved.

According to the present disclosure, there is provided a method of manufacturing a motor rotor. The method includes a first mounting step of mounting the different member in the magnet, a second mounting step of mounting the outer cover member in the magnet, and a magnetizing step of magnetizing the magnet. In the first mounting step, positions of the first recesses and the second recesses are aligned in the circumferential direction of the magnet and the different member is mounted in the magnet. In the magnetizing step, positioning is performed based on the second recesses and the magnet is magnetized.

In this method of manufacturing a motor rotor, the second recesses can be positionally aligned with the first recesses in the circumferential direction of the magnet. In the magnetizing step, the magnet is disposed at a position based on the second recesses, and the direction in which the magnetic poles of the magnet face each other is ascertained, so that the magnet can be magnetized. Since it is no longer necessary to ascertain the direction of the magnetic poles of the magnet by performing preliminary magnetization as in the related art, working steps can be simplified and work efficiency can be improved.

Hereinafter, favorable embodiments of the present disclosure will be described in detail with reference to the drawings. In each of the diagrams, the same reference signs will be applied to the same parts or corresponding parts, and duplicated description thereof will be omitted.

### Electric Turbocharger

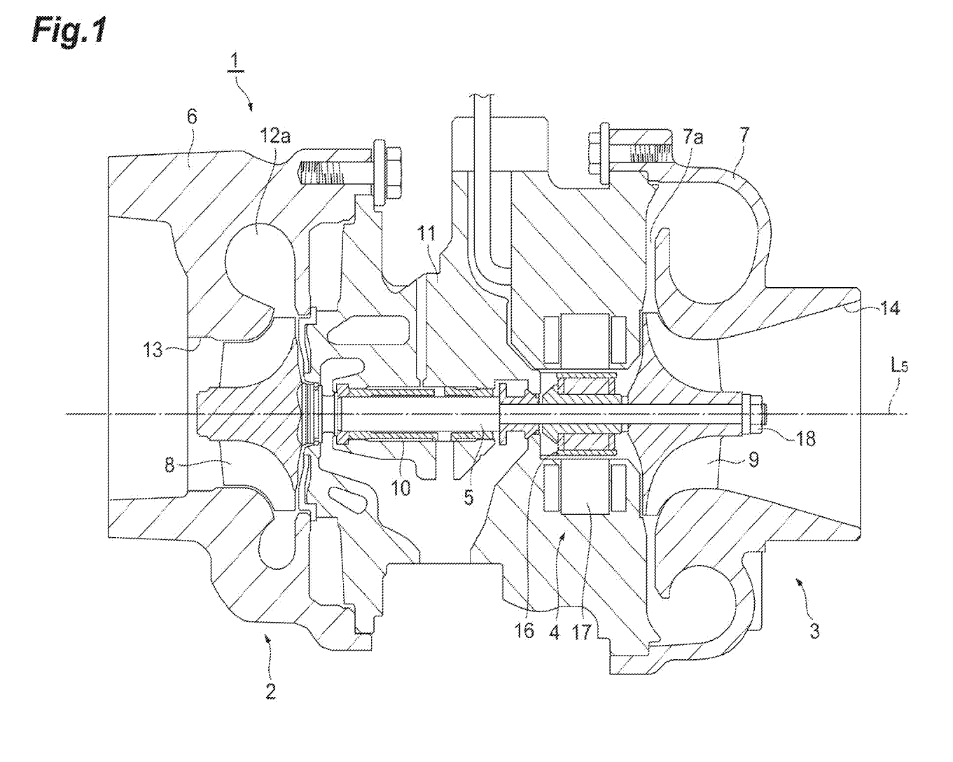

An electric turbocharger 1 illustrated in FIG. 1 is a turbocharger for vehicles, compressing air to be supplied to an engine (not illustrated) utilizing exhaust gas discharged from the engine. This electric turbocharger 1 includes a turbine 2, a compressor (centrifugal compressor) 3, and an electric motor 4. The electric motor 4 applies a rotation driving force to a rotary shaft 5 which is coupled to a compressor impeller 9 of the compressor 3.

The turbine 2 includes a turbine housing 6 and a turbine impeller 8 which is accommodated in the turbine housing 6. The compressor 3 includes a compressor housing 7 and the compressor impeller 9 which is accommodated in the compressor housing 7.

The turbine impeller 8 is provided at one end of the rotary shaft 5, and the compressor impeller 9 is provided at the other end of the rotary shaft 5. A bearing 10 and the electric motor 4 are provided between the turbine impeller 8 and the compressor impeller 9 in an axis L₅ direction of the rotary shaft 5.

A bearing housing 11 is provided between the turbine housing 6 and the compressor housing 7. The rotary shaft 5 is rotatably supported by the bearing housing 11 with the bearing 10 interposed therebetween.

An exhaust gas inflow port (not illustrated) and an exhaust gas outflow port 13 are provided in the turbine housing 6. Exhaust gas discharged from the engine flows into the turbine housing 6 through the exhaust gas inflow port and rotates the turbine impeller 8. Thereafter, the exhaust gas flows out of the turbine housing 6 through the exhaust gas outflow port 13.

An intake port 14 and a discharge port (not illustrated) are provided in the compressor housing 7. As described above, when the turbine impeller 8 rotates, the rotary shaft 5 and the compressor impeller 9 rotate. The rotating compressor impeller 9 takes outside air in through the intake port 14, compresses the air, and discharges the air through the discharge port. The compressed air discharged through the discharge port is supplied to the engine.

### Electric Motor

The electric motor 4 is an AC electric motor, which is, for example, a brushless motor, including a motor rotor 16 (rotor) and a motor stator 17 (stator). The motor rotor 16 is fixed to the rotary shaft 5 to be rotatable around the shaft together with the rotary shaft 5. The motor rotor 16 is disposed between the bearing 10 and the compressor impeller 9 in the axis L₅ direction of the rotary shaft 5.

The motor stator 17 includes a plurality of coils and iron cores. The motor stator 17 is disposed to surround the motor rotor 16 in the circumferential direction of the rotary shaft 5. The motor stator 17 is accommodated in the bearing housing 11. The motor stator 17 generates a magnetic field around the rotary shaft 5 and rotates the motor rotor 16.

The electric motor 4 is adapted to high-speed rotation (for example, 100,000 rpm to 200,000 rpm) of the rotary shaft 5. It is preferable that the electric motor 4 be capable of performing rotation driving during acceleration and regenerative operation during deceleration. It is preferable that the drive voltage of the electric motor 4 be the same as or higher than a DC voltage of a battery mounted in a vehicle.

### Motor Rotor

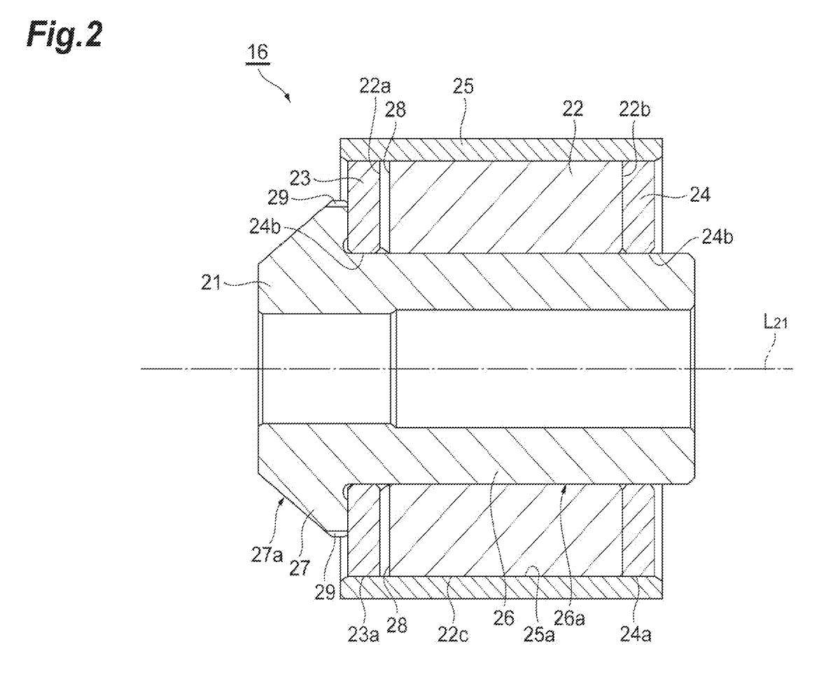

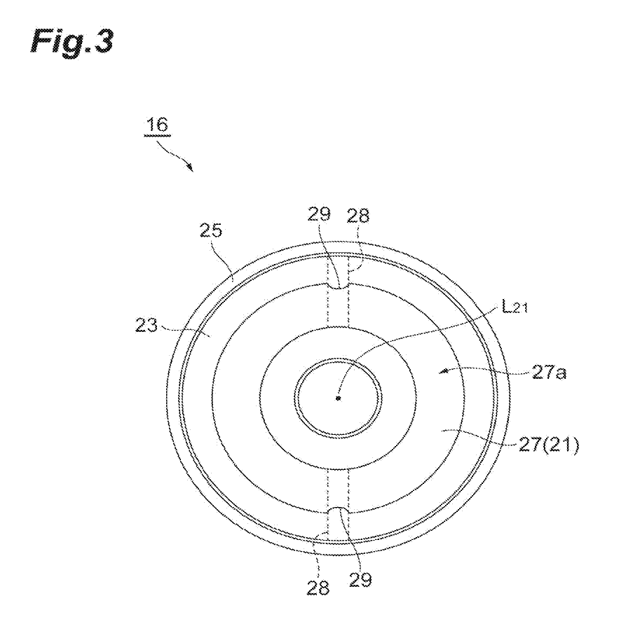

Next, with reference to FIGS. 2 and 3, the motor rotor 16 will be described. FIG. 2 is an enlarged cross-sectional view illustrating the motor rotor 16 in FIG. 1. FIG. 3 is a front view illustrating the motor rotor in the axis L5 direction. FIG. 2 illustrates a cut surface of the motor rotor 16 cut in the axial direction. The motor rotor 16 includes an inner sleeve 21, an annular magnet 22, a pair of end rings 23 and 24, and an armoring (outer cover member) 25.

Examples of the material of the inner sleeve 21 include stainless steel. Examples of the material of the end rings 23 and 24 include stainless steel. Examples of the material of the armoring 25 include high alloy steel. Examples of the material of the magnet 22 include a neodymium magnet.

The inner sleeve 21 includes a cylinder portion 26 and the flange portion (bulging portion) 27. The rotary shaft 5 is inserted through the inside of the opening portion of the cylinder portion 26. The cylinder portion 26 extends in the axis L₅ direction of the rotary shaft 5. The cylinder portion 26 is longer than the magnet 22 and extends to a position on the outer side of the magnet 22 in an axis L₂₁ direction of the inner sleeve 21.

The flange portion 27 is provided on one end side of the cylinder portion 26 in the axis L₂₁ direction. The flange portion 27 is bulged to the outer side in the radial direction beyond an outer circumferential surface 26a of the cylinder portion 26 (inner circumferential surface of the magnet 22). The flange portion 27 is disposed on the outer side of the magnet 22 in the axis L₂₁ direction. For example, an outer circumferential surface 27a of the flange portion 27 is inclined with respect to an axis L₂₁ of the inner sleeve 21. The outer circumferential surface 27a of the flange portion 27 is disposed on the outer side (outer circumferential edge portion) in the axis L₂₁ direction from one end side (left side in the diagram) toward the other end side (right side in the diagram) in the radial direction. In a state in which the inner sleeve 21 is mounted in the rotary shaft 5, one end side of the inner sleeve 21 is disposed on the turbine impeller 8 side, and the other end side of the inner sleeve 21 is disposed on the compressor impeller 9 side.

For example, the magnet 22 is formed to have a cylindrical shape. The magnet 22 is formed to have a plurality of magnetic poles in the circumferential direction. In the magnet 22 of the present embodiment, one N pole and one S pole are formed, that is, two magnetic poles in total are formed in the circumferential direction.

The pair of end rings 23 and 24 are disposed with the magnet 22 interposed therebetween in the axis L₂₁ direction of the inner sleeve 21. The pair of end rings 23 and 24 are disposed to cover end surfaces 22a and 22b of the magnet 22 in the axis L₂₁ direction.

Then, the cylinder portion 26 of the inner sleeve 21 is inserted through the inside of the opening portion of the magnet 22 and the pair of end rings 23 and 24. The end ring 23 covers the end surface 22a of the magnet 22 on the flange portion 27 side, and the end ring 24 covers the end surface 22b of the magnet 22 on a side opposite to the flange portion 27.

An outer circumferential surface 22c of the magnet 22 and outer circumferential surfaces 23a and 24a of the pair of end rings 23 and 24 are formed at positions substantially the same as each other in the radial direction of the rotary shaft 5.

The armoring 25 is formed to have a cylindrical shape. The magnet 22 and the pair of end rings 23 and 24 are disposed inside the opening portion of the armoring 25. The armoring 25 covers the outer circumferential surface 22c of the magnet 22 and the outer circumferential surfaces 23a and 24a of the pair of end rings 23 and 24. The armoring 25 extends to a position on the outer side of the pair of end rings 23 and 24 in the axis L₂₁ direction of the inner sleeve 21. The armoring 25 covers the magnet 22 and the pair of end rings 23 and 24 over the entire circumference thereof.

That is, the magnet 22 is covered with the end rings 23 and 24 from both sides in the axis L₂₁ direction and is covered with the armoring 25 from the outer side in the radial direction, so that the magnet 22 cannot be visually recognized from the outside.

Here, a pair of recesses (first recesses) 28 indicating the intermediate positions between the magnetic poles adjacent to each other in the circumferential direction of the magnet 22 are formed in the magnet 22. For example, as the rotation angle, when the N pole and the S pole are disposed at positions of 0 degrees and 180 degrees, the positions of 90 degrees and 270 degrees become the intermediate positions between the magnetic poles.

In the inner sleeve 21, recesses (second recesses) 29 are respectively formed at positions corresponding to the pair of recesses 28 in the circumferential direction of the inner sleeve 21. The pair of recesses 29 are formed in the inner sleeve 21.

In the magnet 22, the recesses 28 are formed on the end surface 22a on one side in the axis L₂₁ direction. That is, the recesses 28 are formed on an end surface on the flange portion 27 side, that is, an end surface on a side opposite to the turbine impeller 8. The recesses 28 are continuously formed from the inner circumferential side to the outer circumferential side in the radial direction of the magnet 22. The pair of recesses 28 are symmetrically provided about the axis L₂₁. For example, the recesses 28 are formed through cutting work by bringing a side surface of an end mill into contact with the end surface 22a. The recesses 28 can be formed by a working method other than cutting work.

In the inner sleeve 21, the recesses 29 are formed on the outer circumferential surface 27a of the flange portion 27. Specifically, the recesses 29 are provided in an end portion on the end ring 23 side in the axis L₂₁ direction. The recesses 29 are continuously formed in the axis L₂₁ direction. The pair of recesses 29 are symmetrically disposed with the axis L₂₁ interposed therebetween in the radial direction of the magnet 22. For example, the recesses 29 are formed through cutting work by bringing a side surface of the end mill into contact with the outer circumferential surface 27a. The recesses 29 can he formed by a working method other than cutting work. In addition, it is preferable that the widths of the recesses 29 correspond to the widths and the lengths of the recesses 28. However, the widths of the recesses 28 and 29 may be different from each other.

### Method of Manufacturing Motor Rotor

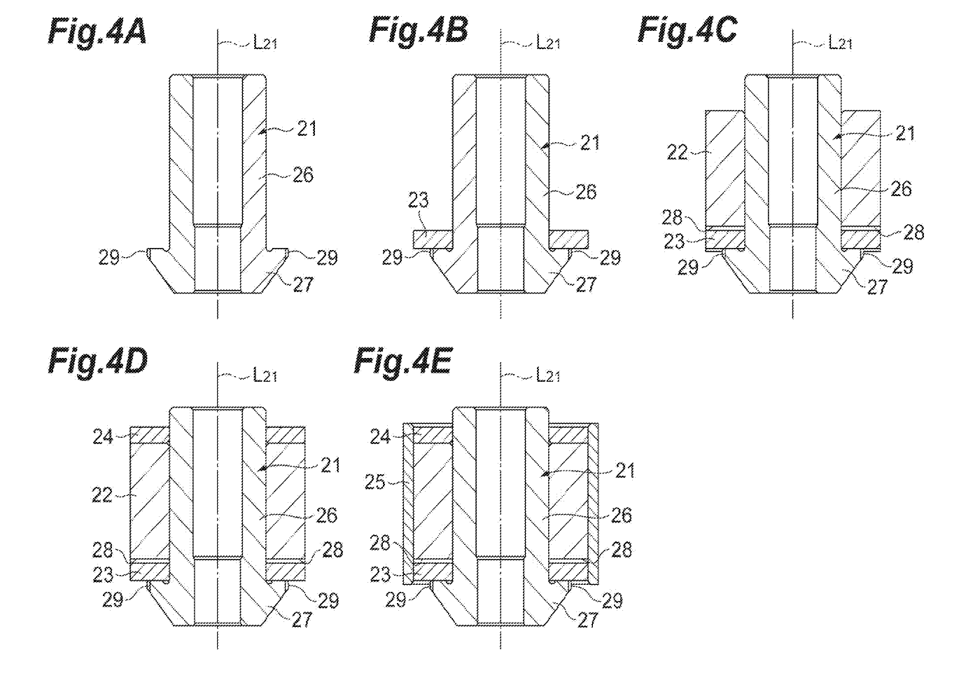

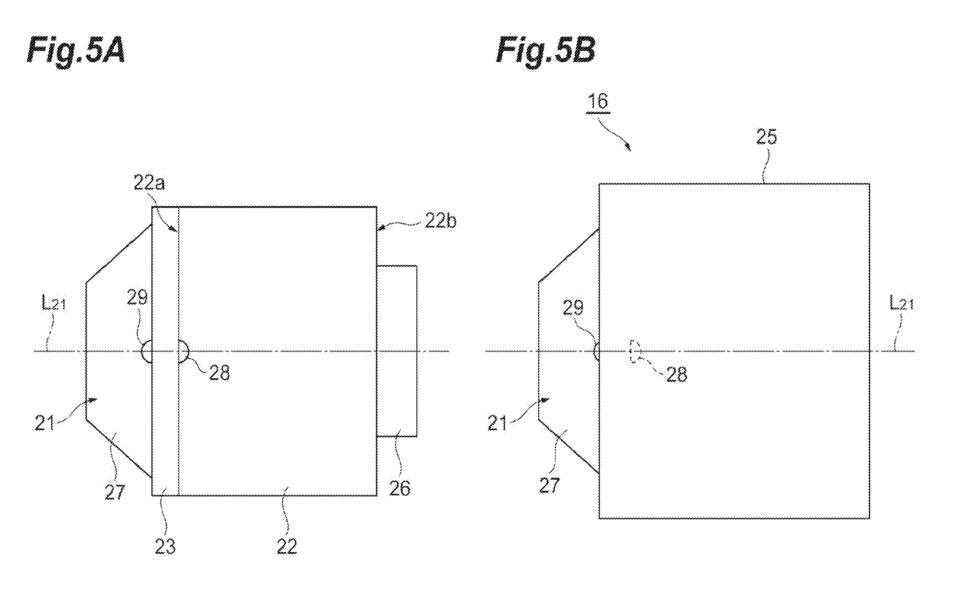

Next, with reference to FIGS. 4 and 5, a method of manufacturing the motor rotor 16 will be described. First, as illustrated in FIG. 4A, the inner sleeve 21 is prepared. For example, the inner sleeve 21 is disposed such that the flange portion 27 is disposed below and the axis L₂₁ direction of the inner sleeve 21 lies along a vertical direction. The inner sleeve 21 is not limited to being disposed in the vertical direction and may be disposed in other directions.

Next, as illustrated in FIG. 4B, the end ring 23 is shrink-fitted into the cylinder portion 26 of the inner sleeve 21. Specifically, the cylinder portion 26 is inserted through the opening portion of the end ring 23, and the end ring 23 is shrink-fitted into the cylinder portion 26 of the inner sleeve 21.

Next, as illustrated in FIG. 4C, the magnet 22 is mounted in the cylinder portion 26 of the inner sleeve 21. Specifically, the end surface 22a, in which the recesses 28 are formed, is disposed on the end ring 23 side, and the cylinder portion 26 is inserted through the opening portion of the magnet 22.

In this case, as illustrated in FIG. 5A, the positions of the recesses 28 of the magnet 22 are aligned with the positions of the recesses 29 of the inner sleeve 21 in the circumferential direction of the inner sleeve 21.

Next, as illustrated in FIG. 4D, the end ring 24 is shrink-fitted into the cylinder portion 26 of the inner sleeve 21. Specifically, the cylinder portion 26 is inserted through the opening portion of the end ring 24, and the end ring 24 is shrink-fitted into the cylinder portion 26 of the inner sleeve 21.

Next, as illustrated in FIG. 4E, the armoring 25 is shrink-fitted into the end rings 23 and 24 and the magnet 22. The inner sleeve 21, the magnet 22, and the end rings 23 and 24 are inserted through the opening portion of the armoring 25, and the minoring 25 is shrink-fitted.

In this case, as illustrated in FIG. 5B, the outer circumferential surface of the end ring 23, the outer circumferential surface of the magnet 22, and the outer circumferential surface of the end ring 24 are covered with the armoring 25, thereby being in a state of not being visually recognizable from the outside.

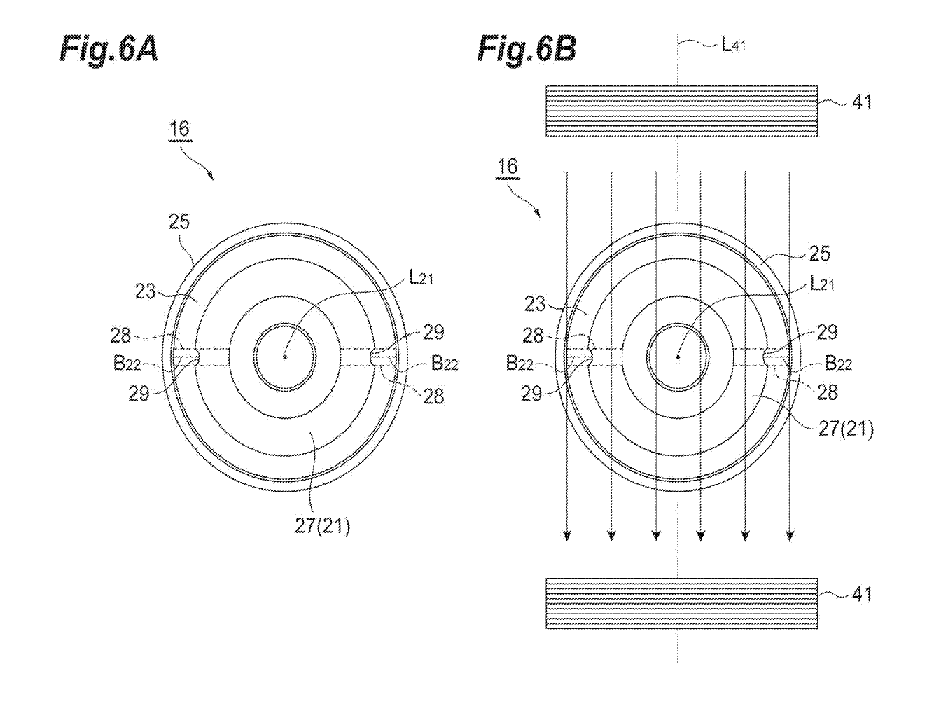

The recesses 29 formed in the flange portion 27 of the inner sleeve 21 are not covered with the armoring 25, thereby being in a state in which the recesses 29 are visually recognizable from the outside. As illustrated in FIG. 6A, the recesses 29 are disposed at the same positions as the recesses 28 of the magnet 22 in the circumferential direction of the motor rotor 16.

Next, the motor rotor 16 is magnetized. When the magnet 22 of the motor rotor 16 having two poles are magnetized, magnetization is performed by using a magnetization apparatus including a pair of coils 41, as illustrated in FIG. 6. The direction in which the magnetic poles of the magnet 22 face each other and the axial direction of the pair of coils 41 are aligned with each other. In the magnet 22, one N pole and one S pole are provided in the circumferential direction. For example, in FIG. 6, the upper side is the N pole, and the lower side is the S pole. In FIG. 6, the direction in which the magnetic poles face each other is the vertical direction in the diagram, and the pair of recesses 29 are disposed at intermediate positions B₂₂ between the magnetic poles. In FIG. 6, the pair of recesses 29 are disposed to face each other in a lateral direction in the diagram.

A worker causes the direction in which the pair of recesses 29 face each other to be disposed in a manner orthogonal to a direction in which an axis L₄₁ of the coils 41 extends and disposes the motor rotor 16 between the pair of coils 41, while visually recognizing the recesses 29 of the inner sleeve 21. Then, the magnet 22 is magnetized by generating a magnetic flux and causing a current to flow in the pair of coils 41.

Next, balance adjustment of the motor rotor 16 is performed. The balance adjustment is performed, for example, by cutting the end portion of the armoring 25 such that the rotation center of the motor rotor 16 is not misaligned.

Then, the motor rotor 16 is attached to the rotary shaft 5. Specifically, the flange portion 27 of the inner sleeve 21 is disposed on the turbine impeller 8 side (side opposite to the compressor impeller 9), and the rotary shaft 5 is inserted through the inside of the opening portion of the inner sleeve 21.

After the inner sleeve 21 is attached to the rotary shaft 5, the compressor impeller 9 is attached to the rotary shaft 5, and a nut 18 is mounted in a screw portion provided in the end portion of the rotary shaft 5. The motor rotor 16 and the compressor impeller 9 are pressed to the turbine impeller 8 side and are fixed to the rotary shaft 5 by fastening the nut 18.

Next, operations of the electric turbocharger 1 will be described.

Exhaust gas which has flowed through the exhaust gas inflow port (not illustrated) passes through a turbine scroll flow channel 12a and is supplied to an inlet side of the turbine impeller 8. The turbine impeller 8 generates a rotation force by utilizing the pressure of the supplied exhaust gas, so that the rotary shaft 5 and the compressor impeller 9 integrally rotate with the turbine impeller 8. Accordingly, air taken in through the intake port 14 of the compressor 3 is compressed using the compressor impeller 9. Air compressed by the compressor impeller 9 passes through a diffuser flow channel 7a and a compressor scroll flow channel 7b and is discharged through the discharge port (not illustrated). The air discharged through the discharge port is supplied to the engine.

This electric motor 4 of the electric turbocharger 1 is adapted to high-speed rotation (for example, 100,000 rpm to 200,000 rpm) of the rotary shaft 5. For example, during acceleration of a vehicle, when the rotation torque of the rotary shaft 5 becomes insufficient, the electric motor 4 transmits a rotation torque to the rotary shaft 5. A battery of the vehicle can be applied as a driving source of the electric motor 4. During deceleration of the vehicle, the electric motor 4 may perform regeneration by rotation energy of the rotary shaft 5.

In the electric motor 4, a magnetic field is generated by the motor stator 17, a rotation force is generated by the magnet 22 of the motor rotor 16 due to this magnetic field. Then, a rotation force of the magnet 22 is transmitted to the rotary shaft 5 via the armoring 25 and the pair of end rings 23 and 24. The compressor impeller 9 rotates in response to the rotation of the rotary shaft 5 and compresses air to be supplied to the engine.

In the motor rotor 16 of the present embodiment, the magnet 22 is covered with the armoring 25, so that the recesses 28 cannot be seen from the outside. Even in a state in which the recesses 28 cannot be seen from the outside, the recesses 29 provided to correspond to the positions of the recesses 28 are disposed at positions visually recognizable from the outside. As illustrated in FIG. 6B, the intermediate positions B₂₂ between the magnetic poles of the magnet 22 can be ascertained by checking the positions of the pair of recesses 29 provided in the inner sleeve 21. Accordingly, in the magnet 22, the direction in which the magnetic poles face each other is discriminated.

Therefore, when the magnet 22 is magnetized in the motor rotor 16, the magnet 22 can be disposed at a correct position and can be magnetized while the positions of the recesses 29 are visually recognized. As a result, it is no longer necessary to perform preliminary magnetization and to ascertain the position at which the magnetic poles of the magnet 22 are disposed, as in the related art. As a result, working steps can be simplified and work efficiency can be improved.

In the motor rotor 16, the pair of recesses 29 are symmetrically formed with the axis of the magnet 22 interposed therebetween. Therefore, misalignment of the rotation center of the motor rotor 16 can be minimized, and time and labor for balance adjustment can be reduced. In addition, when the pair of recesses 29 are formed, visual recognizability is improved, so that it is easy to perform positional alignment of the motor rotor 16.

In the motor rotor 16, the recesses 29 are provided on the outer circumferential surface 27a of the flange portion 27 of the inner sleeve 21. Since the flange portion 27 of the inner sleeve 21 is disposed on the outer side of the armoring 25 in the axis L₂₁ direction, the recesses 29 can be disposed at positions not covered with the armoring 25. The recesses 29 may be formed at partially hidden positions when the motor rotor 16 is seen from the side (in a direction intersecting the axis L₂₁). For example, even in a case in which the recesses 29 cannot be visually recognized when seen from the side, the recesses 29 need only be able to be visually recognized when the motor rotor 16 is seen in the axis L₂₁ direction.

The recesses 29 are disposed at positions close to the end ring 23 in the axis L₂₁ direction of the inner sleeve 21. Since the recesses 29 are disposed at positions near the magnet 22 with the end ring 23 interposed therebetween, it is easy for the recesses 29 to be positionally aligned with the recesses 28.

Since the recesses 29 are formed on the outer circumferential surface 27a of the flange portion 27 of the inner sleeve 21, it is easy to perform working by only bringing the end mill into contact from the side, for example. As illustrated in FIG. 5, if the widths of the recesses 29 and the widths of the recesses 28 are aligned with each other, it is easy for the recesses 29 to be positionally aligned with the recesses 28.

### Second Embodiment

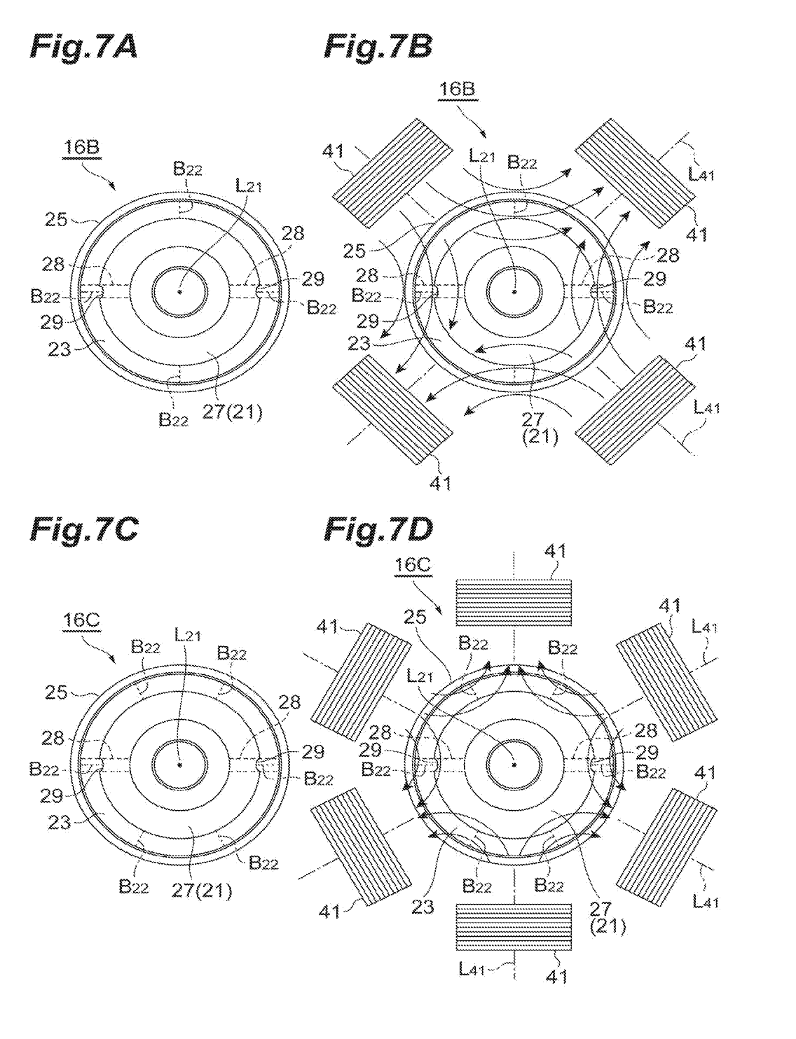

Next, with reference to FIGS. 7A and 7B, a motor rotor 16B according to a second embodiment will be described. The motor rotor 16B of the second embodiment differs from the motor rotor 16 of the first embodiment in including the magnet 22 having four poles, in place of the magnet 22 having two poles. The form of disposing each of the components of the motor rotor 16B is the same as that of the motor rotor 16 of the first embodiment illustrated in FIG. 2.

In the magnet 22 of the motor rotor 16B, two N poles and two S poles are alternately disposed two by two, that is, four magnetic pole in total are formed in the circumferential direction. Then, among four positions of the intermediate positions B₂₂ between the magnetic poles, the recesses 28 and 29 are formed at positions corresponding to a pair of intermediate positions B₂₂ facing each other with the axis of the magnet 22 interposed therebetween. In FIGS. 7A and 7B, the pair of recesses 28 and the pair of recesses 29 are formed while facing each other in the lateral direction in the diagrams. The pair of recesses 28 and the pair of recesses 29 may be disposed while facing each other in a different direction. The recesses 28 and 29 may be formed while facing each other at all of the four intermediate positions B₂₂ between the magnetic poles.

When the magnet 22 of such a quadrupole motor rotor 16B is magnetized, magnetization is performed by using a magnetization apparatus having four coils 41, as illustrated in FIG. 7B. This magnetization apparatus includes two pairs of coils 41, and the directions in which these two pairs of coils 41 face each other are orthogonal to each other. That is, the coils 41 are disposed at positions different from one another by 90 degrees each in the circumferential direction of the magnet 22.

When the motor rotor 16B is magnetized, the pair of recesses 28 are disposed at positions shifted by 45 degrees each around the axis of the magnet 22 with respect to the axis L₄₁ of the pair of coils 41. Accordingly, the direction in which the magnetic poles of the magnet 22 face each other and the direction in which the axis L₄₁ of the pair of coils 41 extends are aligned with each other.

Even in a case of the quadrupole as described above, similar to the first embodiment, magnetization can be performed while having the magnetic poles disposed at correct positions with respect to the coils 41 of the magnetization apparatus. Magnetization efficiency can be improved by correctly disposing the magnetic poles with respect to the coils 41. In addition, since the recesses 28 are visually recognized, the intermediate positions B₂₂ between the magnetic poles of the magnet 22 can be ascertained, and the direction in which the magnetic poles face each other can be discriminated. Therefore, it is no longer necessary to perform preliminary magnetization as before, so that work efficiency is improved.

### Third Embodiment

Next, with reference to FIGS. 7C and 7D, a motor rotor 16C according to a third embodiment will be described. The motor rotor 16C of the third embodiment differs from the motor rotor 16 of the first embodiment in including the magnet 22 having six poles, in place of the magnet 22 having two poles. The form of disposing each of the components of the motor rotor 16C is the same as that of the motor rotor 16 of the first embodiment illustrated in FIG. 2.

In the magnet 22 of the motor rotor 16B, three N poles and three S poles are alternately disposed three by three, that is, six magnetic poles in total are formed in the circumferential direction. Then, among six positions of the intermediate positions B₂₂ between the magnetic poles, the recesses 28 and 29 are formed at positions corresponding to a pair of intermediate positions B₂₂ facing each other with the axis of the magnet 22 interposed therebetween. In FIGS. 7C and 7D, the pair of recesses 28 and the pair of recesses 29 are formed while facing each other in the lateral direction in the diagram. The pair of recesses 28 and the pair of recesses 29 may be disposed while facing each other in a different direction. The recesses 28 and 29 may be formed while facing each other at all of the six intermediate positions B₂₂ between the magnetic poles.

When the magnet 22 of such a hexapole motor rotor 16C is magnetized, magnetization is performed by using a magnetization apparatus having six coils 41, as illustrated in FIG. 7D. This magnetization apparatus includes three pairs of coils 41, and the directions in which these three pairs of coils 41 face each other are shifted by 60 degrees each. The coils 41 are disposed at positions different from one another by 60 degrees each in the circumferential direction of the magnet 22.

When the motor rotor 16C is magnetized, the pair of recesses 28 are disposed at positions shifted by 30 degrees each around the axis of the magnet 22 with respect to the axis L₄₁ of the pair of coils 41. The recesses 28 are disposed at the intermediate positions of the axes L₄₁ adjacent to each other in the circumferential direction of the magnet 22. Accordingly, the direction in which the magnetic poles of the magnet 22 face each other and the direction in which the axis L₄₁ of the pair of coils 41 extends are aligned with each other.

Even in a case of the hexapole as described above, similar to the first embodiment, magnetization can be performed while having the magnetic poles disposed at correct positions with respect to the coils 41 of the magnetization apparatus. Magnetization efficiency can be improved by correctly disposing the magnetic poles with respect to the coils 41. In addition, since the recesses 28 are visually recognized, the intermediate positions B₂₂ between the magnetic poles of the magnet 22 can be ascertained, it is no longer necessary to perform preliminary magnetization as before, so that work efficiency is improved.

### Modification Example

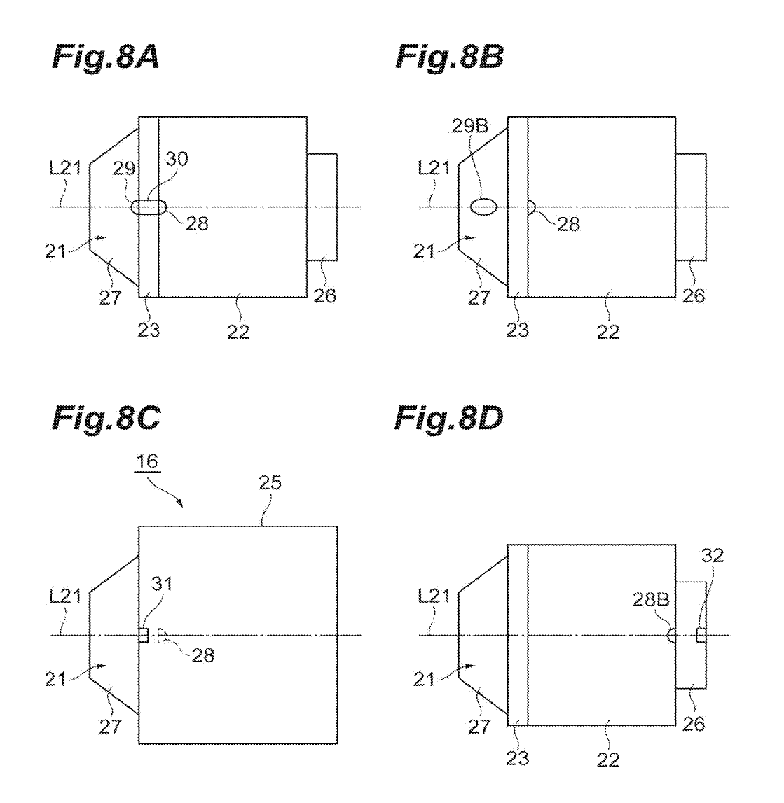

Next, with reference to FIG. 8, motor rotors according to modification examples will be described. The motor rotors according to the modification examples differ from the motor rotor 16 of the first embodiment in the form of disposing the recess.

As illustrated in FIG. 8A, in a motor rotor according to a first modification example, a recess (second recess) 30 is provided in the end ring 23. In this case, the positions of the recesses 29, 30, and 28 are aligned in the circumferential direction of the motor rotor. Accordingly, when the positions of the recesses 28 and 29 are aligned, positional alignment can be performed due to the recess 30 therebetween, so that positional alignment can be easily performed.

As illustrated in FIG. 8B, in a motor rotor according to a second modification example, a recess (second recess) 29B is provided in the intermediate position of the flange portion 27 in the axis L₂₁ direction of the inner sleeve 21. In this case, the positions of the recesses 28 and 29B are aligned in the circumferential direction of the motor rotor. In this manner, the recess 29B does not have to be provided in the end portion on the end ring 23 side.

As illustrated in FIG. 8C, in a motor rotor according to a third modification example, a recess (second recess) 31 is provided in the armoring 25. In this case, the positions of the recesses 28 and 31 are aligned in the circumferential direction of the motor rotor. In this manner, the recess 31 may be provided in the different member other than the inner sleeve 21.

As illustrated in FIG. 8D, in a motor rotor according to a fourth modification example, a recess (first recess) 28B is provided in place of the recess 28, and a recess (second recess) 32 is provided in place of the recess 29. The recess 28B provided in the magnet 22 is provided in the end portion on a side opposite to the flange portion 27 in the axis L₂₁ direction. The recess 32 provided in the inner sleeve 21 is provided in the end portion on a side opposite to the flange portion in the axis L₂₁ direction. In this manner, the recess may be provided in the end portion on a side opposite to (compressor impeller side) of the flange portion 27.

The present invention is not limited to the embodiments described above, and various changes as described below can be made within a range not departing from the gist of the present invention.

The embodiments have described a configuration in which the flange portion 27 is provided in the inner sleeve 21. However, the inner sleeve 21 may be configured to have no flange portion 27 bulging to the outer side in the radial direction. The inner sleeve 21 may have a different configuration. For example, the inner sleeve 21 and the end ring 23 may be configured to be integrally formed.

The embodiments have described an example of the electric turbocharger 1 for vehicles. However, the electric turbocharger 1 is not limited to being used for vehicles. The electric turbocharger 1 may be used in an engine for watercraft or may be used in other engines.

The embodiments have described a configuration in which the electric turbocharger 1 includes the turbine 2. However, the electric turbocharger 1 may be driven by the electric motor 4 without having the turbine 2.

The embodiments have described a case in which the motor rotor 16 is applied to the electric motor 4 of the electric turbocharger 1. However, the motor rotor 16 can be used in not only the electric turbochargers but also in other electric motors. The motor rotor 16 can be used as a rotor for electric dynamos.

### INDUSTRIAL APPLICABILITY

According to the present disclosure, working steps can be simplified and efficiency of assembling work can be improved when the magnet of the motor rotor is magnetized.

### REFERENCE SIGNS LIST

1 Electric turbocharger

2 Turbine

3 Compressor

4 Electric motor

5 Rotary shaft

8 Turbine impeller

9 Compressor impeller

16, 16B, 16C Motor rotor

21 Inner sleeve

22 Magnet

22c Outer circumferential surface of magnet

25 Armoring (outer cover member)

27 Flange portion (bulging portion)

28, 28B Recess (first recess)

29, 29B, 30, 31, 32 Recess (second recess)

B₂₂ Intermediate position between magnetic poles adjacent to each other

L₂₁ Axis of inner sleeve (axis of magnet)

1.-8. (canceled)

9. A motor rotor comprising:
an annular magnet;
a tubular outer cover member that covers an outer circumferential surface of the magnet; and
a different member that is located at a position outside the magnet in an axial direction of the magnet,
wherein the magnet includes one or a plurality of first recesses indicating an intermediate position between magnetic poles adjacent to each other in a circumferential direction of the magnet,
wherein the different member includes one or a plurality of second recesses provided in the circumferential direction of the magnet to correspond to positions of the first recesses, and
wherein in a state in which the outer cover member covers the magnet, the second recesses are disposed at positions visually recognizable from outside.

10. The motor rotor according to claim 9,
wherein a pair of the second recesses symmetrically disposed with an axis of the magnet interposed therebetween are formed in a radial direction of the magnet in the different member.

11. The motor rotor according to claim 9,
wherein the different member includes an inner sleeve inserted through the inside of an opening portion of the magnet,
wherein the inner sleeve includes a bulging portion which bulges to a position on an outer side of the magnet in the axial direction of the magnet, and
wherein the second recesses are provided in the bulging portion of the inner sleeve.

12. The motor rotor according to claim 9,
wherein the second recesses are formed in a part of the different member on the magnet side in the axial direction of the magnet.

13. The motor rotor according to claim 9,
wherein the second recesses are formed at positions on an outer side of the outer cover member in the axial direction of the magnet.

14. The motor rotor according to claim 9,
wherein the different member includes a flange portion which bulges to an outer side beyond an inner circumferential surface of the magnet in a radial direction of the magnet, and
wherein the second recesses are formed in an outer circumferential edge portion of the flange portion.

15. A turbocharger equipped with an electric motor including the motor rotor according to claim 9, the turbocharger comprising:
a rotary shaft;
a turbine impeller that is coupled to one end side of the rotary shaft;
a compressor impeller that is coupled to the other end side of the rotary shaft; and
the electric motor that includes the motor rotor mounted in the rotary shaft.

16. A method of manufacturing the motor rotor according to claim 9, the method comprising:
a first mounting step of mounting the different member in the magnet;
a second mounting step of mounting the outer cover member in the magnet; and
a magnetizing step of magnetizing the magnet,
wherein in the first mounting step, positions of the first recesses and the second recesses are aligned in the circumferential direction of the magnet and the different member is mounted in the magnet, and
wherein in the magnetizing step, positioning is performed based on the second recesses and the magnet is magnetized.
